(19) United States
(12) Patent Application Publication
(10) Pub. No.: US 2017/0176893 A1
(43) Pub. Date: Jun. 22, 2017

(54) IMAGE FORMING APPARATUS

(71) Applicant: FUJI XEROX CO., LTD., Tokyo (JP)

(72) Inventor: Yasuto OKABAYASHI, Kanagawa (JP)

(73) Assignee: FUJI XEROX CO., LTD., Tokyo (JP)

(21) Appl. No.: 15/153,225

(22) Filed: May 12, 2016

(30) Foreign Application Priority Data
Dec. 21, 2015 (JP) 2015-248488

(51) Int. Cl. G03G 15/00

(52) U.S. Cl. CPC G03G 15/161

(57) ABSTRACT

An image forming apparatus includes an image forming device and a controller. The image forming device forms toner images on an image holding member and transfers the toner images to recording media. When images to be transferred to the recording media are borderless images and the toner images are continuously formed on the respective recording media, the controller extends an image forming pitch compared to the image forming pitch used in a case where images transferred to the recording media are not borderless images.

### CROSS-REFERENCE TO RELATED APPLICATIONS

This application is based on and claims priority under 35 USC 119 from Japanese Patent Application No. 2015-248488 filed Dec. 21, 2015.

### BACKGROUND

### Technical Field

The present invention relates to an image forming apparatus.

### SUMMARY

According to an aspect of the present invention, an image forming apparatus includes an image forming device and a controller. The image forming device forms toner images on an image holding member and transfers the toner images to recording media. When images to be transferred to the recording media are borderless images and the toner images are continuously formed on the respective recording media, the controller extends an image forming pitch compared to the image forming pitch used in a case where images transferred to the recording media are not borderless images.

### BRIEF DESCRIPTION OF THE DRAWINGS

Exemplary embodiment of the present invention will be described in detail based on the following figure, wherein:

FIG. 1 is a schematic sectional view of an internal structure of an image forming apparatus;

FIG. 2 is a block diagram illustrating an example of a functional configuration of the image forming apparatus;

FIG. 3A illustrates bordered printing, and FIG. 3B illustrates borderless printing;

FIGS. 4A to 4C illustrate formation of a toner image for borderless printing;

FIG. 5 illustrates toner images of image data and image-quality-adjustment toner images formed on an intermediate transfer belt in bordered printing;

FIG. 6 illustrates toner images of image data and image-quality-adjustment toner images formed on the intermediate transfer belt in borderless printing;

FIG. 7A schematically illustrates a sequence of resistance detection performed between sheets in the bordered printing, and FIG. 7B schematically illustrates the relationship between the toner images and spacing between the sheets formed in the borderless printing;

FIG. 8 is a flowchart illustrating the flow of operation of the image forming apparatus;

FIG. 9 illustrates the relationship between inter image regions and the toner images of the image data formed on the intermediate transfer belt in a productivity priority mode in which the borderless printing is performed; and

FIG. 10 illustrates the relationship between inter image regions and the toner images of the image data formed on the intermediate transfer belt in an image quality priority mode in which the borderless printing is performed.

### DETAILED DESCRIPTION

Next, an exemplary embodiment and a specific example of the present invention will be described in further detail below with reference to the drawings. It should be understood that the present invention is not limited to the exemplary embodiment and the specific example.

Furthermore, it should be noted that the drawings referred to in the following description are schematically illustrated and, for example, not to scale, and illustration of elements not required for the description is omitted as appropriate for ease of understanding.

### (1) An Overall Structure and Operation of an Image Forming Apparatus

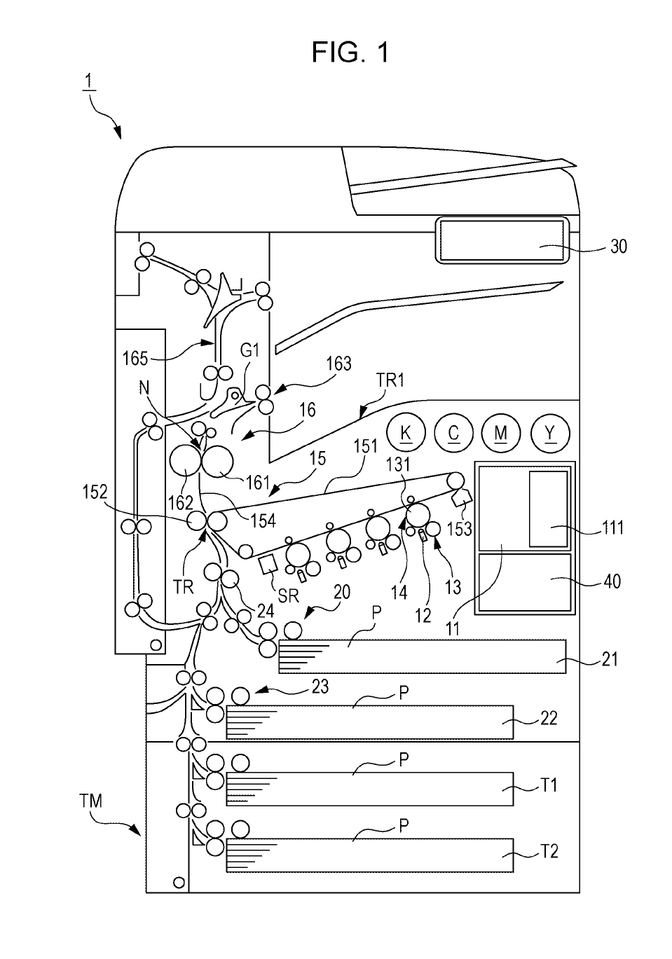

FIG. 1 is a schematic sectional view of an internal structure of an image forming apparatus 1 according to the present exemplary embodiment.

An overall structure and operation of the image forming apparatus 1 are described below with reference to the drawings.

### (1.1) The Overall Structure of the Image Forming Apparatus

The image forming apparatus 1 includes an image forming section 10, a sheet feed device 20 attached at a bottom portion of the image forming section 10, an operating information unit 30, and an image processing unit 40.

The image forming section 10 includes a system controller 11, light exposure devices 12, photosensitive units 13, developing devices 14, a transfer device 15, and a fixing device 16. The image forming section 10 receives image information from the image processing unit 40 and forms the image information about sheets of paper P fed from the sheet feed device 20 as toner images.

The sheet feed device 20 that includes sheet trays 21 and 22 is provided at the bottom portion of the image forming section 10. Furthermore, a tray module TM is connected to a lower portion of the sheet feed device 20 so as to feed the sheets P to the image forming section 10. The tray module TM includes sheet trays T1 and T2 that are vertically stacked to form a multi-tray structure (two trays according to the present exemplary embodiment) and that contain the sheets P.

That is, plural trays that contain different types (for example, material, thickness, sheet size, and paper grain) of the sheets P are provided, and each of the sheets P fed from the corresponding one of these plural trays is supplied to the image forming section 10.

The operating information unit 30 corresponds to a so-called user interface. Specifically, the operating information unit 30 includes a liquid crystal display panel, various operating buttons, a touch panel, and so forth combined with one another, so that the operating information unit 30 is used to input various settings and instructions and display information.

The image processing unit 40 generates image data from print information transmitted from an external device (not illustrated; for example, personal computer or the like).

### (1.2) A Structure and Operation of the Image Forming Section

In the image forming apparatus 1 having such a structure, the sheets P are fed from the trays of the sheet feed device 20 or the tray module TM to the image forming section 10 at timing adjusted to timing of image formation, that is, an image forming pitch. The trays of these sheets P are specified by print jobs on a sheet-by-sheet basis for printing.

The photosensitive units 13 are arranged in parallel to one another above (Z direction) the sheet feed device 20. The photosensitive units 13 include respective photosensitive drums 131 that are rotated. Electrostatic latent images are formed on the photosensitive drums 131 by the light exposure devices 12. Toner image components of yellow (Y), magenta (M), cyan (C), and black (K) are formed by the respective developing devices 14 on the photosensitive drums 131 bearing these electrostatic latent images.

The toner image components of the colors formed on the photosensitive drums 131 of the respective photosensitive units 13 are sequentially electrostatically transferred (first transfer) onto an intermediate transfer belt 151 of the transfer device 15 with the predetermined image forming pitch, so that superposed toner images that each include the toner image components of the colors are formed with the predetermined image forming pitch. The toner image components of each of the superposed toner images on the intermediate transfer belt 151 are collectively transferred by a second transfer roller 152 onto one of the sheets P fed from a registration roller pair 24 and guided by a transport guide.

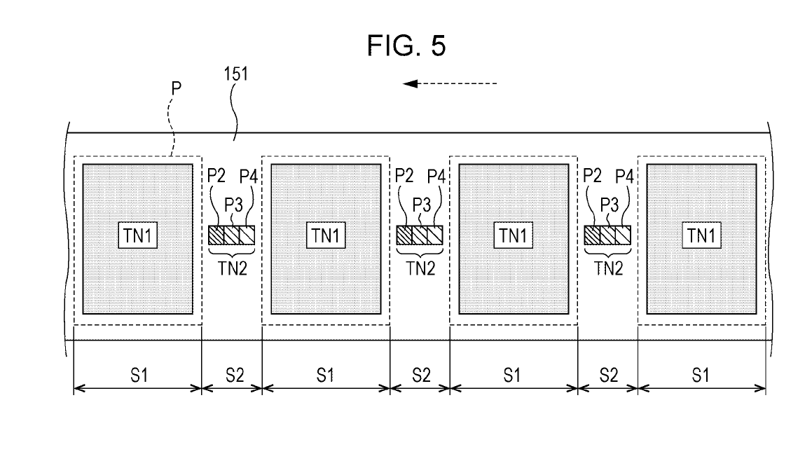

A density sensor SR is disposed adjacent to the photosensitive unit 13 (K) along the intermediate transfer belt 151 so as to face intermediate transfer belt 151. The density sensor SR reads image-quality-adjustment toner images TN2 (see FIG. 5) of the colors having been transferred onto the intermediate transfer belt 151 through the first transfer and detects the densities of the image-quality-adjustment toner mages TN2. The system controller 11 adjusts the densities of the toner image components of the colors in accordance with results obtained through the reading. The image-quality-adjustment toner images TN2, which are not transferred onto the sheet P, are removed by a belt cleaner 153 without being processed.

The fixing device 16 includes a pair of a heating module 161 and a pressure module 162, which are in pressure contact with each other in a pressure contact region so as to define a fixing nip N (fixing region).

The sheet P onto which the toner image components have been collectively transferred by the transfer device 15 is transported to the fixing nip N of the fixing device 16 through a transport guide 154 while the toner image components are still unfixed. In this fixing nip N, the toner image components are fixed by actions of pressure and heat applied thereto by the pair of the heating module 161 and the pressure module 162.

The sheet P on which a fixed toner image has been formed is guided to a switching gate G1 so as to be, through a first output roller pair 163, output to and received in a sheet output tray TR1 provided in an upper surface of the image forming apparatus 1. Furthermore, in order to invert the sheet P for duplex printing or output the sheet P with an image recording side facing upward, a transport direction of the sheet P is changed toward a transport path 165 by the switching gate G1.

### (2) A Functional Configuration of the Image Forming Apparatus 1

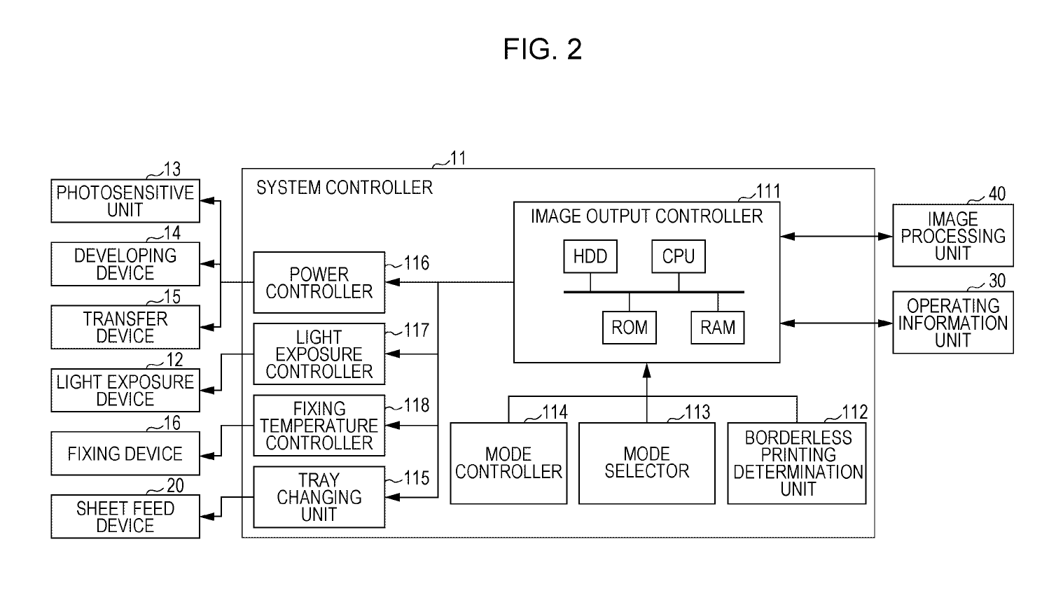

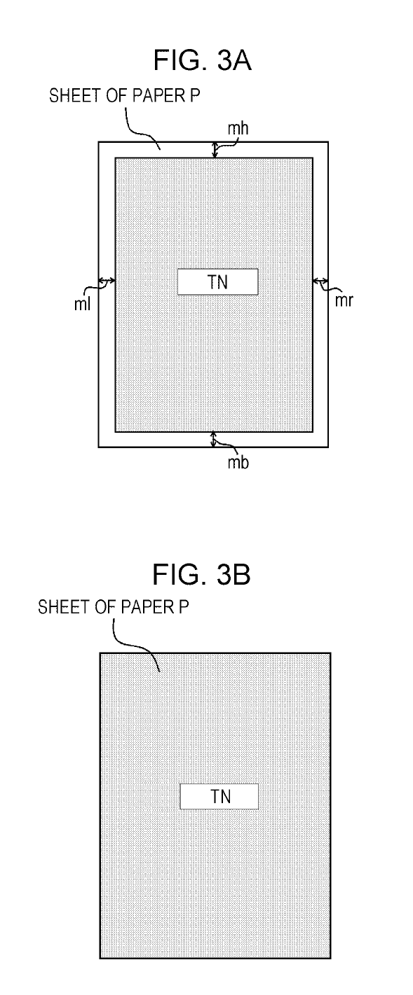

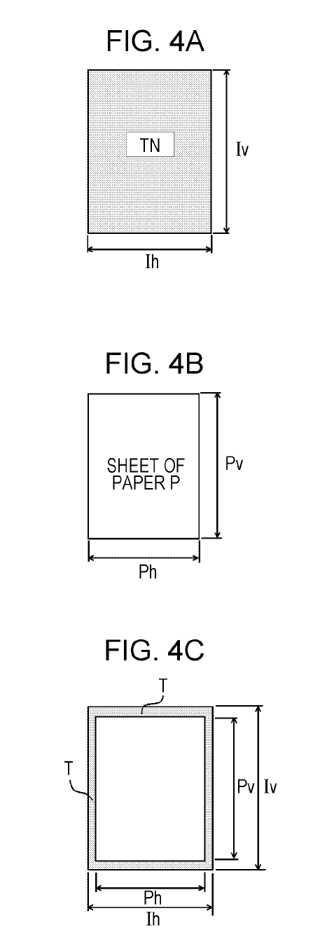

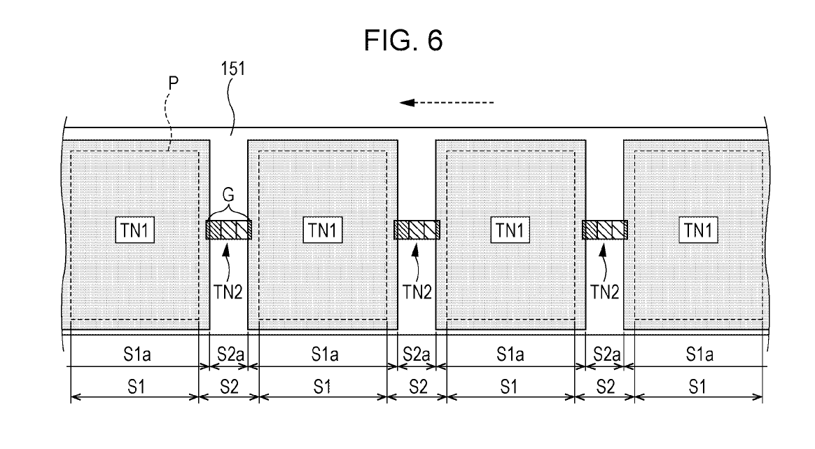

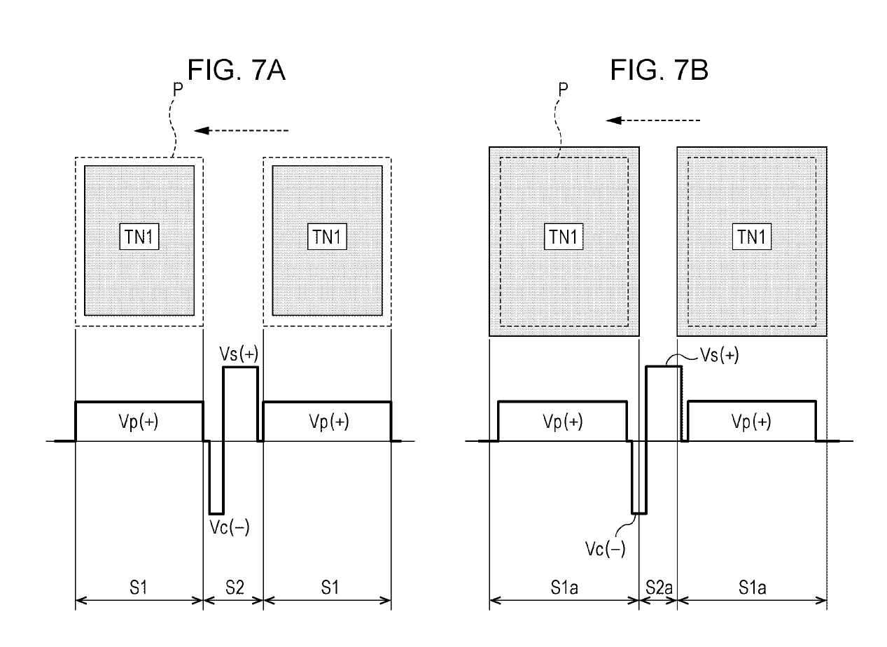

FIG. 2 is a block diagram illustrating an example of a functional configuration of the image forming apparatus 1. FIG. 3A illustrates bordered printing, and FIG. 3B illustrates borderless printing. FIGS. 4A to 4C illustrate formation of a toner image in the borderless printing. FIG. 5 illustrates toner images TN1 of image data and the image-quality-adjustment toner images TN2 formed on the intermediate transfer belt 151 in bordered printing. FIG. 6 illustrates the toner images TN1 of image data and the image-quality-adjustment toner images TN2 formed on the intermediate transfer belt 151 in the borderless printing. FIG. 7A schematically illustrates a sequence of resistance detection performed between sheets in bordered printing, and FIG. 7B schematically illustrates the relationship between the toner images and spacing between the sheets formed in the borderless printing.

### (2.1) The Functional Configuration of the System Controller

The image forming apparatus 1 includes the system controller 11 that serves as an example of a controller and that includes an image output controller 111, a borderless printing determination unit 112, a mode selector 113, a mode controller 114, a tray changing unit 115, a power controller 116, a light exposure controller 117, and a fixing temperature controller 118. The system controller 11 controls operation of the entire image forming apparatus 1 by executing a control program stored in memory.

The image output controller 111 controls exchanging of information with the sheet feed device 20. In addition, the image output controller 111 issues operating control instructions to the following components included in the image forming section 10: that is, the light exposure devices 12, the photosensitive units 13, the developing devices 14, the transfer device 15, the fixing device 16, and so forth.

Furthermore, the image output controller 111 issues operating control instructions to the following controllers included in the system controller 11: that is, the power controller 116, the light exposure controller 117, and the fixing temperature controller 118. That is, the image output controller 111 determines whether or not to supply power to and whether or not to drive the components included in the image forming section 10, that is, the light exposure devices 12, the photosensitive units 13, the developing devices 14, the transfer device 15, the fixing device 16, and so forth and issues the results of the determination to the controllers of these components.

Furthermore, the image output controller 111 exchanges information with the borderless printing determination unit 112, the mode selector 113, and the mode controller 114 so as to perform predetermined operating control when the borderless printing is determined.

The borderless printing determination unit 112 detects the presence or absence of peripheral margins around received image data with respect to the sheet P so as to determine whether the image is a borderless image or a bordered image.

As schematically illustrated in FIG. 3A, in the bordered image, a toner image TN entirely fits in the sheet P with a top margin (mh), a bottom margin (mb), a left margin (ml), and a right margin (mr) set as the peripheral margins at the periphery of the sheet P.

In contrast, in the borderless image, as illustrated in FIG. 3B, the toner image TN extends to end portions of the sheet P, and accordingly, none of the peripheral margins are set. Referring to FIG. 3B, there is no top margin, bottom margin, left margin, or right margin. However, when at least one of the end portions does not have its margin, it is determined that the image is a borderless image.

In accordance with an accepted image forming instruction, the mode selector 113 selects a mode to be adopted for image forming from among a standard printing mode, a productivity priority mode, a first image quality priority mode, and a second image quality priority mode. In the standard printing mode, the borderless printing is not performed. In the productivity priority mode, the borderless printing is performed. In the first image quality priority mode, the borderless printing is performed. In the second image quality priority mode, the borderless printing is performed.

The mode selector 113 according to the present exemplary embodiment selects the mode in accordance with reference information about the area coverage of the image data, the type of the image of the image data, and the type of a recording medium included in the image forming instruction.

The mode controller 114 performs a predetermined image forming operation in accordance with the mode selected by the mode selector 113.

### (2.2) Borderless Printing

The image forming apparatus 1 has a bordered printing mode and a borderless printing mode. In the bordered printing mode (meaning the same as the standard printing mode hereafter), the image is printed on the sheet P with the margins set along the end portions at the entire periphery of the sheet P. In the borderless printing mode, the image printed on the sheet P extends to the end portions of the sheet P without the margins.

Whether or not the borderless printing mode is to be performed is determined by the borderless printing determination unit 112 of the system controller 11 that controls the operation of the image forming apparatus 1.

FIG. 4A illustrates the size of the toner image formed on the intermediate transfer belt 151. In FIG. 4A, Iv represents the vertical size and Ih represents the horizontal size. FIG. 4B illustrates the size of the sheet P. In FIG. 4B, the Pv represents the vertical size and Ph represents the horizontal size.

As schematically illustrated in FIG. 4C, the relationships of the sizes of the toner image and the sheet P are set so that Pv<Iv and Ph<Ih. That is, the size of the toner image TN is formed slightly larger than the size of the selected sheet P so that the margins are not set in the sheet P even when the sheet P is fed with the position thereof slightly misaligned vertically and horizontally.

The toner image TN having a size of Iv×Ih indicated by a shaded region is formed on the intermediate transfer belt 151. The toner image TN having a size of Iv×Ih is transported by the intermediate transfer belt 151 toward a second transfer portion TR. Meanwhile, timing control of the sheet P is performed by the registration roller pair 24 so that the sheet P is transported to the second transfer portion TR at timing adjusted to timing at which the toner image TN enters the second transfer portion TR. A borderless toner image TN without the margins at the periphery is formed on the sheet P.

### (2.3) Image Quality Adjustment

The image forming apparatus 1 forms the image-quality-adjustment toner images TN2 on the intermediate transfer belt 151, and the density sensor SR reads the image-quality-adjustment toner images TN2 having been formed so as to detect the densities of the image-quality-adjustment toner images TN2. In accordance with results obtained through the reading, the system controller 11 adjusts the densities of the toner image components of the colors as an example of correction of image forming conditions.

As illustrated in FIG. 5, in the standard printing mode in which the borderless printing is not performed, the toner images TN1 of the image data to be printed are held in image regions S1. The image-quality-adjustment toner images TN2 are formed in inter image regions S2 between the adjacent image regions S1.

The inter image regions S2 coincide with spacing between preceding sheets and the following sheets in the standard printing mode. According to need of improvement of productivity, the length of the inter image regions S2 is a minimum length required for forming required image-quality-adjustment toner images TN2. Furthermore, according to the present exemplary embodiment, the image-quality-adjustment toner images TN2 include image-quality-adjustment toner images P2, P3, and P4 that are continuously formed in accordance with patch data for three sheets corresponding to the image data for three sheets to be used to form images later.

The image-quality-adjustment toner images P2, P3, and P4 are determined corresponding to the image data for three sheets to be used to form images and each include, for example, eight patch images. Since the length of the inter image regions S2 is small, eight patch images each have a rectangular shape of 1 mm×1 mm and are spaced apart from one another by 1 mm.

FIG. 6 illustrates the relationship between the toner images TN1 of image data and the image-quality-adjustment toner images TN2 formed on the intermediate transfer belt 151 in the borderless printing.

In the borderless printing mode, the size of the toner images TN1 of the image data is increased to the size of the image regions S1a larger than the size of the image regions S1 which is the same as the size of the sheets. As a result, inter image regions S2a between the adjacent image regions S1a are smaller than the inter image regions S2 of the standard printing mode. Accordingly, there are regions G where the toner images TN1 and the image-quality-adjustment toner images TN2 formed in the inter image regions S2a are superposed on one another.

In order to address this, when the number of each of the image-quality-adjustment toner images P2, P3, and P4 included in the image-quality-adjustment toner images TN2 is reduced, the correction of the image forming conditions is not necessarily sufficiently performed.

### (2.4) Transfer Control

In regions between the preceding sheets and the succeeding sheets corresponding to the inter image regions S2, the image forming apparatus 1 applies to the second transfer roller 152 a resistance detecting voltage Vs (+) having the same polarity as that of a transfer voltage Vp (+) and a cleaning voltage Vc (−) having the opposite polarity to that of the transfer voltage Vp (+) so as to detect the electrical resistance of the second transfer portion TR. While detecting the electrical resistance of the second transfer portion TR, correction of the intensity of the transfer voltage applied to the second transfer roller 152 is performed as an example of the correction of the image forming conditions.

As illustrated in FIG. 7A, in the standard printing mode in which the borderless printing is not performed, the toner images TN1 of the image data to be printed are held in the image regions S1. The length of the inter image regions S2 between the adjacent image regions S1 is the same as the length of spacing between the sheets. The resistance detecting voltage Vs (+) and the cleaning voltage Vc (−) are applied to these inter image regions S2.

In contrast, as illustrated in FIG. 7B, in the borderless printing mode, the size of the toner images TN1 of the image data is increased to the size of the image regions S1a larger than the size of the image regions S1, which is the same as the size of the sheets. As a result, the inter image regions S2a between the adjacent image regions S1a are smaller than the inter image regions S2 of the standard printing mode. This may cause a situation in which the resistance detection is not necessarily correctly performed due to a lack of a time period in which the resistance detecting voltage Vs (+) and the cleaning voltage Vc (−) are applied.

(3) Image Forming Operation with Mode Selection

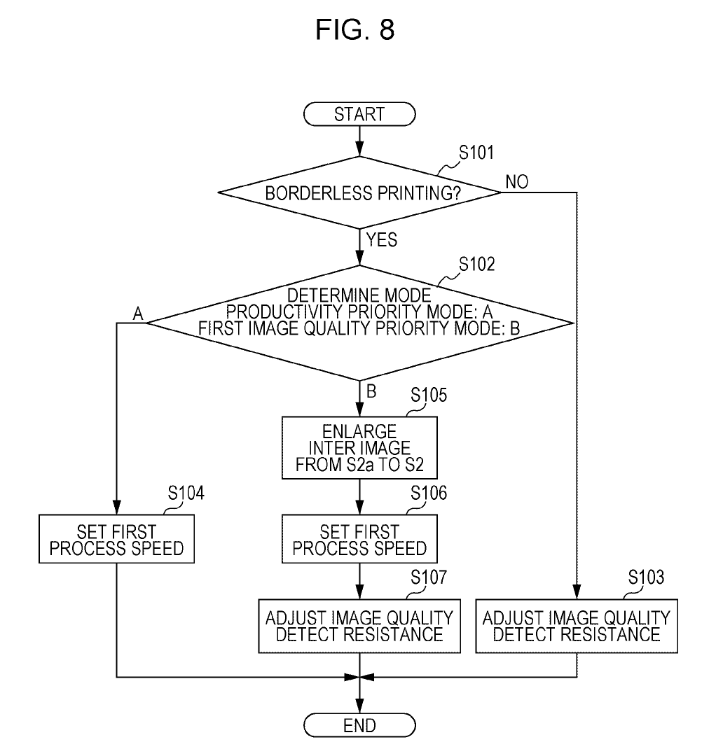

FIG. 8 is a flowchart illustrating the flow of operation of the image forming apparatus 1.

Operating control in the borderless printing is described below with reference to the drawings.

In the image forming apparatus 1 according to the present exemplary embodiment, if an accepted print job is determined to be performed in the borderless printing mode, then a mode to be adopted for image forming is selected from among the productivity priority mode in which the borderless printing is performed and the first image quality priority mode in which the borderless printing is performed, and a predetermined image forming operation is performed in accordance with the selected mode.

Upon reception of the print job, the system controller 11 causes the borderless printing determination unit 112 to determine whether to perform the borderless printing or the bordered printing for the accepted print job (S101). Specifically, whether or not there are the top margin (mh), the bottom margin (mb), the left margin (ml), and the right margin (mr) at the periphery of the sheet P is detected. When at least one end portion does not have the margin, it is determined that the borderless printing is to be performed.

If it is determined that the borderless printing mode is to be performed in step 101, then the mode selector 113 further selects a mode to be adopted for the image forming from among the productivity priority mode (A) in which the borderless printing is performed and the first image quality priority mode (B) in which the borderless printing is performed (S102). When there are margins at four edges (“NO” in S101), printing in the standard printing mode is performed at a first process speed without any change while the image quality adjustment and the resistance detection are performed (S103).

The mode is selected in accordance with reference information about the area coverage of the image data, the type of the image of the image data, and the type of the recording medium included in the image forming instruction.

Specifically, a raster image generated by the image processing unit 40 is analyzed on a pixel-by-pixel basis, and the productivity priority mode is selected when the type of the image is identified as a line drawing or characters. In contrast, the first image quality priority mode is selected when the type of the image is a picture, a photograph, or the like in a color expressed by toners of two or more colors, and includes pixels with which the area coverage is a specified value or a higher value.

Regarding the mode selection, in addition to the area coverage, the type of the image, and the type of the recording medium included in the image forming instruction, the productivity priority mode (A) or the first image quality priority mode (B) in which the borderless printing is performed may be directly accepted through the operating information unit 30.

If the productivity priority mode (A) is selected in step S102 (“A” in S102), the first process speed is set (S104) as in the bordered printing mode, and printing is performed without performing the image quality adjustment. Furthermore, the resistance detection for transfer control is not performed on the inter image regions S2. In this case, the resistance detection is performed, for example, only at the start of the job so as to perform the transfer control.

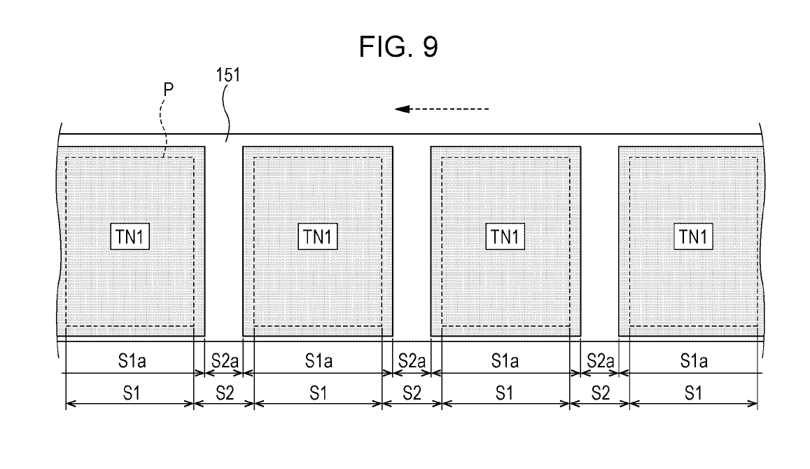

FIG. 9 illustrates the relationship between the inter image regions S2a and the toner images TN1 of the image data formed on the intermediate transfer belt 151 in the productivity priority mode in which the borderless printing is performed. In the productivity priority mode in which the borderless printing is performed, the size of the toner images TN1 of the image data is increased to the size of the image regions S1a larger than the size of the image regions S1 which is the same as the size of the sheets. As a result, the inter image regions S2a between the adjacent image regions S1a are smaller than the inter image regions S2 of the standard printing mode. Accordingly, printing is performed at the first process speed without forming the image-quality-adjustment toner images TN2 in the inter image regions S2a for the image quality adjustment.

This may allow the borderless printing to be performed with productivity similar to or the same as that with the standard printing mode.

If the first image quality priority mode (B) is selected in step S102 (“B” in S102), the image forming pitch is extended so as to increase the size of the inter image regions S2a to the size of the inter image regions S2 of the standard printing mode where formation of the image-quality-adjustment toner images TN2 is possible (S105). Then, the first process speed is set (S106) as in the standard printing mode so as to perform printing while the image quality adjustment and the resistance detection are performed (S107).

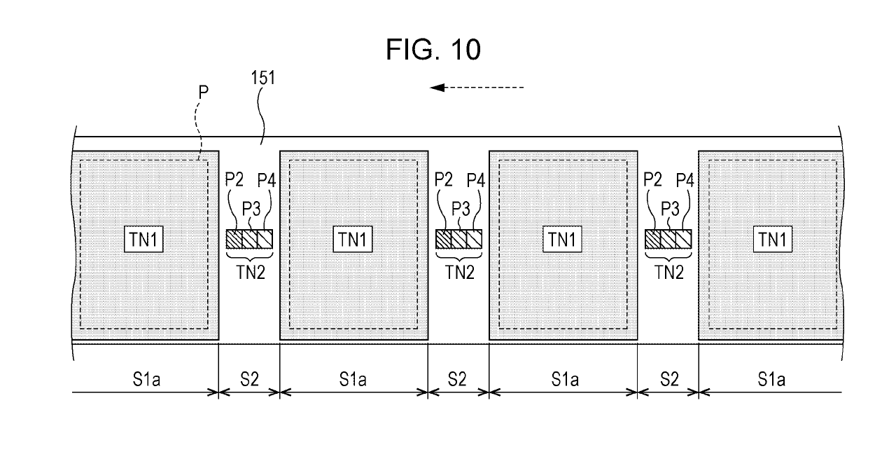

FIG. 10 illustrates the relationship between the inter image regions S2 and the toner images TN1 of the image data formed on the intermediate transfer belt 151 in the first image quality priority mode in which the borderless printing is performed. In the first image quality priority mode in which the borderless printing is performed, the size of the toner images TN1 of the image data is increased to the size of the image regions S1a larger than the size of the image regions S1 which is the same as the size of the sheets. Furthermore, the image forming pitch is extended so that the size of the inter image regions S2a between the adjacent image regions S1a is increased to the size of the inter image regions S2 of the standard printing mode. Thus, formation of the image-quality-adjustment toner images TN2 for the image quality adjustment is possible in the inter image regions S2a. Furthermore, the resistance detection is possible as in the standard printing mode in the inter image regions S2 having an increased size.

Accordingly, borderless printing of images including, for example, pictures or photographs as the type of the image may be performed while maintaining a high image quality without largely reducing the productivity compared to that with the standard printing mode.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming device that forms toner images on an image holding member and transfers the toner images to recording media; and
a controller that, when images to be transferred to the recording media are borderless images and the toner images are continuously formed on the respective recording media, extends an image forming pitch compared to the image forming pitch used in a case where images transferred to the recording media are not borderless images.

2. The image forming apparatus according to claim 1,
wherein each of the toner images is formed in accordance with an image forming instruction that includes reference information about an area coverage, a type of an image, and a type of a recording medium, and
wherein the controller extends the image forming pitch in accordance with the reference information.

3. The image forming apparatus according to claim 1,
wherein spacing that allows, on the image holding member, formation therein of image-quality-adjustment toner images used to correct image forming conditions for the toner images is set in accordance with the image forming pitch.

4. The image forming apparatus according to claim 2,
wherein spacing that allows, on the image holding member, formation therein of image-quality-adjustment toner images used to correct image forming conditions for the toner images is set in accordance with the image forming pitch.

5. The image forming apparatus according to claim 1,
wherein spacing that allows therein detection of resistance of the image forming device that transfers the toner images to the recording media is set in accordance with the image forming pitch.

6. The image forming apparatus according to claim 2,
wherein spacing that allows therein detection of resistance of the image forming device that transfers the toner images to the recording media is set in accordance with the image forming pitch.

7. The image forming apparatus according to claim 3,
wherein spacing that allows therein detection of resistance of the image forming device that transfers the toner images to the recording media is set in accordance with the image forming pitch.

8. The image forming apparatus according to claim 4,
wherein spacing that allows therein detection of resistance of the image forming device that transfers the toner images to the recording media is set in accordance with the image forming pitch.
